(19) United States
(12) Patent Application Publication
(10) Pub. No.: US 2019/0186445 A1
(43) Pub. Date: Jun. 20, 2019

(54) BLOW-BY GAS PROCESSING DEVICE, AND ENGINE

(71) Applicant: TOYOTA JIDOSHA KABUSHIKI KAISHA, Toyota-shi (JP)

(72) Inventor: Masami Ishikawa, Aichi-gun (JP)

(73) Assignee: TOYOTA JIDOSHA KABUSHIKI KAISHA, Toyota-shi (JP)

(21) Appl. No.: 16/209,460

(22) Filed: Dec. 4, 2018

(30) Foreign Application Priority Data
Dec. 14, 2017 (JP) 2017-239935

(51) Int. Cl. F02M 35/10; F02M 25/06; F01M 13/02; F02M 26/19

(52) U.S. Cl. CPC F02M 35/10222; F02M 26/19; F01M 13/02; F02M 25/06

(57) ABSTRACT

A blow-by gas processing device includes a blow-by gas pipe through which blow-by gas flows. A peripheral wall of the blow-by gas pipe is provided with a plurality of communication holes arranged in an extending direction of the blow-by gas pipe. A farthest communication hole, which is a communication hole located farthest from a base end of the blow-by gas pipe in the extending direction among the plurality of communication holes, is provided in a distal end portion of the blow-by gas pipe. A guide wall portion is provided in a part of the peripheral wall, which is located on the opposite side of a central axis of the blow-by gas pipe from a position of the farthest communication hole. The guide wall portion approaches the blow-by gas introduced portion as the guide wall portion extends toward a distal end of the blow-by gas pipe in the extending direction.

### INCORPORATION BY REFERENCE

The disclosure of Japanese Patent Application No. 2017-239935 filed on Dec. 14, 2017 including the specification, drawings and abstract is incorporated herein by reference in its entirety.

### BACKGROUND

### 1. Technical Field

The disclosure relates to a blow-by gas processing device including a blow-by gas pipe through which blow-by gas to be introduced into an intake pipe flows, and relates also an engine.

### 2. Description of Related Art

A blow-by gas processing device described in Japanese Patent No. 3051391 includes a blow-by gas pipe extending in a direction in which a crankshaft of an engine extends (hereinafter, referred to as “extending direction of the crankshaft”). An inlet portion through which the blow-by gas flows into the blow-by gas pipe is disposed at a base end portion of the blow-by gas pipe. In addition, a peripheral wall of the blow-by gas pipe is provided with a plurality of communication holes arranged in a direction in which the blow-by gas pipe extends (hereinafter, referred to as “extending direction of the blow-by gas pipe”). The blow-by gas pipe communicates with an intake pipe through the communication holes. Thus, the blow-by gas flowing through the blow-by gas pipe is introduced into the intake pipe through the communication holes.

### SUMMARY

The communication holes arranged in the extending direction of the blow-by gas pipe include a farthest communication hole. The farthest communication hole is a communication hole located farthest from the inlet portion, among the communication holes described above. In the blow-by gas pipe described above, the farthest communication hole is located closer to the inlet portion than a distal end portion of the blow-by gas pipe is. Thus, in the distal end portion of the blow-by gas pipe, the blow-by gas accumulates without being introduced into the intake pipe.

When the blow-by gas pipe is applied to an engine that is mounted in a vehicle such that the extending direction of a crankshaft substantially coincides with the front-rear direction of the vehicle, the air flowing from a front side of the vehicle collides with the distal end portion of the blow-by gas pipe, in which the blow-by gas accumulates. When the temperature of the air that collides with the distal end portion as described above is considerably low, moisture contained in the blow-by gas that has accumulated in the distal end portion may freeze, leading to blockage of the farthest communication hole. As a result, the blow-by gas in the blow-by gas pipe may not be easily introduced into the intake pipe through the farthest communication hole. When the blow-by gas is hindered from being introduced into the intake pipe through at least one of the communication holes, the blow-by gas is not easily mixed homogeneously with intake air in the intake pipe. This may cause variations in the amounts of blow-by gas to be introduced into respective cylinders.

In view of this, the blow-by gas processing device described above still has room for improvement in terms of reduction of accumulation of the blow-by gas in the distal end portion of the blow-by gas pipe. The disclosure provides a blow-by gas processing device including a blow-by gas pipe configured to reduce accumulation of blow-by gas in a distal end portion of the blow-by gas pipe, and provides an engine.

A first aspect of the disclosure relates to a blow-by gas processing device for an engine including an intake pipe. The blow-by gas processing device includes a blow-by gas pipe through which blow-by gas flows. The blow-by gas flows into the blow-by gas pipe from a base end of the blow-by gas pipe. The blow-by gas pipe is disposed on a blow-by gas introduced portion that is a part of the intake pipe of the engine. A peripheral wall of the blow-by gas pipe is provided with a plurality of communication holes arranged in an extending direction of the blow-by gas pipe. The blow-by gas in the blow-by gas pipe is introduced into the blow-by gas introduced portion through the plurality of communication holes. A farthest communication hole is provided in a distal end portion of the blow-by gas pipe. The farthest communication hole is included in the plurality of communication holes. The farthest communication hole is located farthest from the base end of the blow-by gas pipe in the extending direction of the blow-by gas pipe, among the plurality of communication holes. A guide wall portion is provided in a part of the peripheral wall of the blow-by gas pipe. The part of the peripheral wall, in which the guide wall portion is provided, is located on the opposite side of a central axis of the blow-by gas pipe from a position of the farthest communication hole. The guide wall portion is configured to approach the blow-by gas introduced portion as the guide wall portion extends toward a distal end of the blow-by gas pipe in the extending direction of the blow-by gas pipe.

According to the first aspect, the blow-by gas that has flowed into the blow-by gas pipe from the base end flows toward the distal end of the blow-by gas pipe. The blow-by gas flows into the plurality of communication holes, and is then introduced into the blow-by gas introduced portion of the intake pipe through the plurality of communication holes.

In the first aspect, the farthest communication hole is provided in the peripheral wall of the blow-by gas pipe such that the farthest communication hole is located in the distal end portion of the blow-by gas pipe. In addition, the guide wall portion is provided in the part of the peripheral wall of the blow-by gas pipe. Thus, the blow-by gas flowing toward the distal end of the blow-by gas pipe is guided toward the farthest communication hole by the guide wall portion. The blow-by gas that has been guided toward the farthest communication hole by the guide wall portion is introduced into the blow-by gas introduced portion of the intake pipe through the farthest communication hole. As a result, it is possible to reduce the occurrence of a situation where the blow-by gas accumulates in the distal end portion of the blow-by gas pipe without flowing into the farthest communication hole. It is therefore possible to reduce accumulation of the blow-by gas in the distal end portion of the blow-by gas pipe. Thus, even when the distal end portion of the blow-by gas pipe is exposed to low-temperature air, the moisture contained in the blow-by gas is restrained from freezing in the distal end portion. As a result, blockage of the farthest communication hole is reduced. Thus, it is possible to reduce the occurrence of a situation where the blow-by gas is not easily introduced into the intake pipe through the farthest communication hole.

If the guide wall portion inclined as described above is provided so as to extend over a wide region, the internal volume of the blow-by gas pipe is small. In view of this, the guide wall portion may be located closer to the distal end of the blow-by gas pipe than a second-farthest communication hole is. The second-farthest communication hole is included in the plurality of communication holes, and the second-farthest communication hole is adjacent to the farthest communication hole in the extending direction of the blow-by gas pipe. With this configuration, the internal volume of the blow-by gas pipe is less likely to be smaller than that when the guide wall portion extends to a position that is closer to the base end than the second-farthest communication hole is.

A second aspect of the disclosure relates to an engine including: an intake pipe including a blow-by gas introduced portion; and a blow-by gas processing device including a blow-by gas pipe through which blow-by gas flows. The blow-by gas flows into the blow-by gas pipe from a base end of the blow-by gas pipe. The blow-by gas pipe is disposed on the blow-by gas introduced portion. A peripheral wall of the blow-by gas pipe is provided with a plurality of communication holes arranged in an extending direction of the blow-by gas pipe. The blow-by gas in the blow-by gas pipe is introduced into the blow-by gas introduced portion through the plurality of communication holes. A farthest communication hole is provided in a distal end portion of the blow-by gas pipe. The farthest communication hole is included in the plurality of communication holes. The farthest communication hole is located farthest from the base end of the blow-by gas pipe in the extending direction of the blow-by gas pipe among the plurality of communication holes. A guide wall portion is provided in a part of the peripheral wall of the blow-by gas pipe. The part of the peripheral wall, in which the guide wall portion is provided, is located on the opposite side of a central axis of the blow-by gas pipe from a position of the farthest communication hole. The guide wall portion is configured to approach the blow-by gas introduced portion as the guide wall portion extends toward a distal end of the blow-by gas pipe in the extending direction of the blow-by gas pipe.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a front view schematically illustrating an engine to which a blow-by gas processing device according to an embodiment is applied;

FIG. 2 is a plan view schematically illustrating a blow-by gas pipe of the blow-by gas processing device and an intake pipe of the engine;

FIG. 3 is a sectional view taken along line in FIG. 2, and illustrating a sectional shape of the blow-by gas pipe and a part of a sectional shape of a surge tank included in the intake pipe; and

FIG. 4 is a sectional view illustrating the blow-by gas pipe included in the blow-by gas processing device and a part of the surge tank included in the intake pipe according to another embodiment.

### DETAILED DESCRIPTION OF EMBODIMENTS

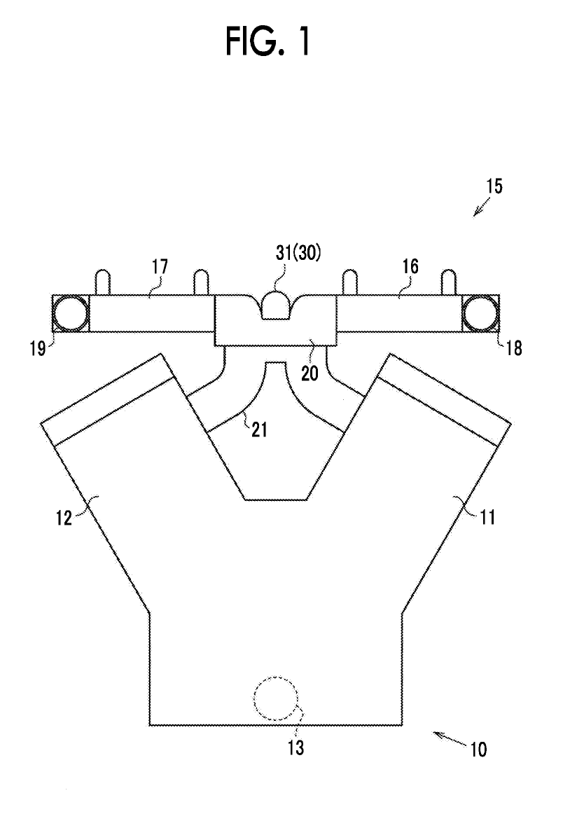

Hereinafter, a blow-by gas processing device according to an embodiment will be described with reference to FIG. 1 to FIG. 3. FIG. 1 schematically illustrates an engine 10 to which a blow-by gas processing device 30 according to the present embodiment is applied. As illustrated in FIG. 1, the engine 10 is a V-engine including a first bank 11 and a second bank 12. Each of the first bank 11 and the second bank 12 includes a plurality of cylinders arranged in a direction in which a crankshaft 13 extends (hereinafter, referred to as “extending direction of the crankshaft 13”).

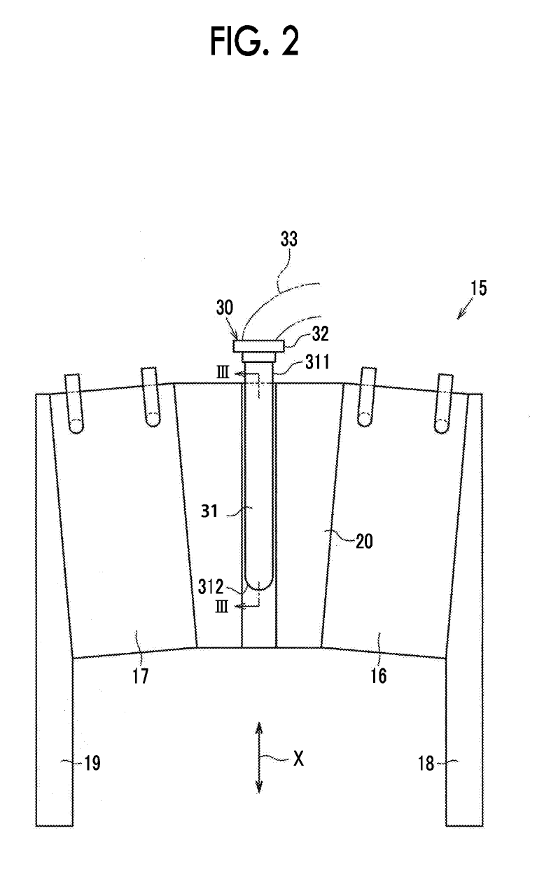

As illustrated in FIG. 1 and FIG. 2, an intake pipe 15 of the engine 10 includes a first intercooler 16 disposed above the first bank 11, and a second intercooler 17 disposed above the second bank 12. Intake air flows into the first intercooler 16 through a first pipe 18. Similarly, intake air flows into the second intercooler 17 through a second pipe 19. The intake pipe 15 further includes a surge tank 20 disposed between the first intercooler 16 and the second intercooler 17, and an intake manifold 21 connected to the surge tank 20. The intake air that has been cooled by the first intercooler 16 and the intake air that has been cooled by the second intercooler 17 flow into the surge tank 20. Then, the intake air that has flowed from the surge tank 20 into the intake manifold 21 is introduced into each of the cylinders.

The blow-by gas processing device 30 includes a blow-by gas pipe 31 configured to introduce the blow-by gas into the intake pipe 15. A predetermined direction X that is a direction in which the blow-by gas pipe 31 extends (hereinafter, referred to as “extending direction of the blow-by gas pipe 31”) as indicated by an arrowed line in FIG. 2 substantially coincides with the extending direction of the crankshaft 13. The blow-by gas pipe 31 is disposed on the surge tank 20. That is, the surge tank 20 in the present embodiment is an example of “blow-by gas introduced portion” which is included in the intake pipe 15, and into which the blow-by gas is introduced through the blow-by gas pipe 31.

As illustrated in FIG. 2, an inlet portion 32 through which the blow-by gas flows into the blow-by gas pipe 31 is disposed at a base end portion 311 (an upper end portion in FIG. 2) of the blow-by gas pipe 31 in the predetermined direction X. A tube 33 through which the blow-by gas flows is connected to the inlet portion 32.

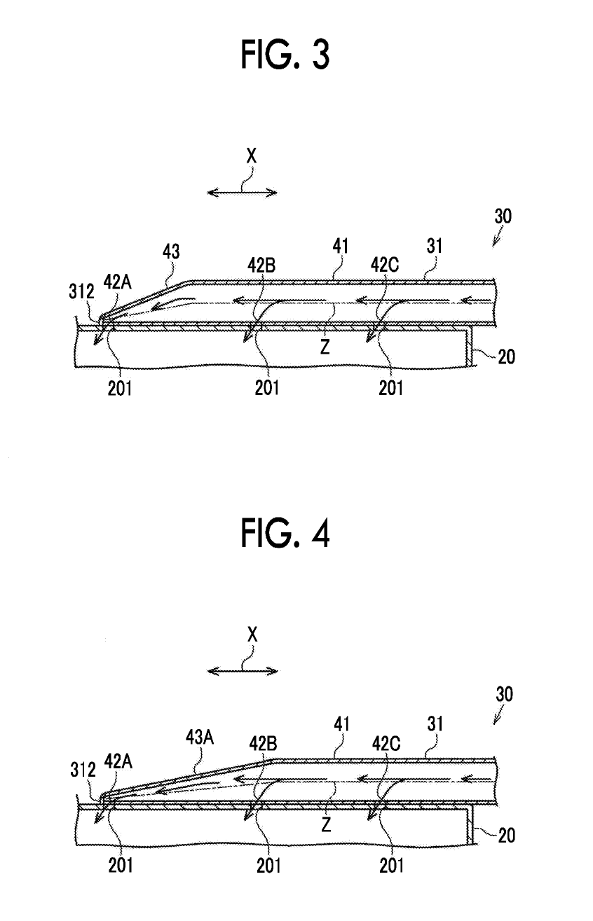

As illustrated in FIG. 3, a part (a lower part in FIG. 3) of a peripheral wall 41 of the blow-by gas pipe 31, which faces the surge tank 20, is provided with a plurality of (three in an example illustrated in FIG. 3) communication holes 42A, 42B, 42C arranged in the predetermined direction X. That is, the part provided with the communication holes 42A, 42B, 42C faces the surge tank 20. Further, a part of the surge tank 20, on which the blow-by gas pipe 31 is disposed, is provided with a plurality of through-holes 201 corresponding to the communication holes 42A, 42B, 42C. The number of the through-holes 201 is equal to the number of the communication holes 42A, 42B, 42C. Thus, the blow-by gas in the blow-by gas pipe 31 is introduced into the surge tank 20 through the communication holes 42A, 42B, 42C and the through-holes 201 corresponding to the communication holes 42A, 42B, 42C.

A first communication hole 42A among the communication holes 42A, 42B, 42C is provided in a distal end portion 312 (a left end portion in FIG. 3) of the blow-by gas pipe 31 in the predetermined direction X. That is, among the communication holes 42A, 42B, 42C, the first communication hole 42A is located farthest from the inlet portion 32. Further, among the communication holes 42A, 42B, 42C, a third communication hole 42C is located closest to the inlet portion 32. In addition, among the communication holes 42A, 42B, 42C, a second communication hole 42B is located between the first communication hole 42A and the third communication hole 42C. That is, the second communication hole 42B is adjacent to the first communication hole 42A in the predetermined direction X. Therefore, the first communication hole 42A in the present embodiment is an example of “farthest communication hole”, and the second communication hole 42B in the present embodiment is an example of “second-farthest communication hole”.

A part of the peripheral wall 41 of the blow-by gas pipe 31 serves as a guide wall portion 43 configured to guide the blow-by gas to the first communication hole 42A. The guide wall portion 43 is located on the opposite side of a central axis Z of the blow-by gas pipe 31 from a position of the first communication hole 42A, and is located closer, in the predetermined direction X, to the distal end of the blow-by gas pipe 31 than the second communication hole 42B is (i.e., is located on the left side of the second communication hole 42B in FIG. 3). The guide wall portion 43 is inclined with respect to the predetermined direction X such that the guide wall portion 43 approaches (i.e., the guide wall portion 43 is closer to) the surge tank 20 as the guide wall portion 43 extends toward the distal end of the blow-by gas pipe 31 in the predetermined direction X. That is, the guide wall portion 43 is inclined with respect to the predetermined direction X such that the distance between the guide wall portion 43 and the surge tank 20 decreases as the guide wall portion 43 extends toward the distal end of the blow-by gas pipe 31 in the predetermined direction X.

The operation and advantageous effect of the present embodiment will be described below. The blow-by gas that has flowed into the blow-by gas pipe 31 through the inlet portion 32 flows toward the distal end as indicated by arrowed lines in FIG. 3. The blow-by gas flows into the communication holes 42A, 42B, 42C, and is then introduced into the surge tank 20 through the communication holes 42A, 42B, 42C, and the through-holes 201.

In the present embodiment, the first communication hole 42A is provided in the peripheral wall 41 of the blow-by gas pipe 31 such that the first communication hole 42A is located in the distal end portion 312 of the blow-by gas pipe 31. In addition, the guide wall portion 43 is provided in the part of the peripheral wall 41 of the blow-by gas pipe 31 such that the guide wall portion 43 is located closer to the distal end of the blow-by gas pipe 31 than the second communication hole 42B is. Thus, the blow-by gas flowing toward the distal end of the blow-by gas pipe 31 is guided toward the first communication hole 42A by the guide wall portion 43. The blow-by gas that has been guided toward the first communication hole 42A by the guide wall portion 43 is introduced into the surge tank 20 through the first communication hole 42A and the through-hole 201 that communicates with the first communication hole 42A. As a result, it is possible to reduce the occurrence of a situation where the blow-by gas accumulates in the distal end portion 312 of the blow-by gas pipe 31 without flowing into the first communication hole 42A.

When the engine 10 is disposed in an engine compartment, for example, such that the extending direction of the crankshaft 13 substantially coincides with the vehicle front-rear direction, the distal end portion 312 of the blow-by gas pipe 31 is a front end portion of the blow-by gas pipe 31 in the vehicle front-rear direction. In this case, the air flowing from a front side of the vehicle collides with the distal end portion 312. When the temperature of the air that collides with the distal end portion 312 is considerably low, the moisture contained in the blow-by gas may freeze in the distal end portion 312. In this regard, according to the present embodiment, it is possible to reduce accumulation of the blow-by gas in the distal end portion 312. Thus, it is possible to restrain the moisture contained in the blow-by gas from freezing in the distal end portion 312.

The moisture contained in the blow-by gas is restrained from freezing in the distal end portion 312 as described above, and thus blockage of the first communication hole 42A is restrained. Thus, it is possible to reduce the occurrence of a situation where the blow-by gas is not easily introduced into the surge tank 20 through the first communication hole 42A. That is, the blow-by gas can be appropriately introduced into the surge tank 20 through the first communication hole 42A. Thus, even when the distal end portion 312 of the blow-by gas pipe 31 is exposed to low-temperature air, it is possible to reduce the occurrence of a situation where the blow-by gas is not easily mixed homogeneously with the intake air in the surge tank 20. As a result, it is possible to reduce variations in the amounts of the blow-by gas to be introduced into the respective cylinders.

The foregoing embodiment may be modified as follows. The foregoing embodiment and modified examples described below may be combined with each other within a range where a technical contradiction does not arise.

For example, as illustrated in FIG. 4, the blow-by gas pipe 31 may be configured such that a guide wall portion 43A extends to a position that is closer, in the predetermined direction X, to the base end portion 311 than the second communication hole 42B is. As long as the peripheral wall 41 of the blow-by gas pipe 31 is provided with a plurality of communication holes, the number of the communication holes provided in the peripheral wall 41 may be two, or may be four or greater (for example, five).

An engine to which the blow-by gas processing device is applied may be an engine (for example, an inline engine) other than a V-engine. A part of the intake pipe, to which the blow-by gas pipe 31 is attached, may be a part of the intake pipe other than the surge tank 20. The blow-by gas pipe 31 may be attached to, for example, the intake manifold 21, so that the blow-by gas can be introduced into each branch pipe of the intake manifold 21 through a communication hole. The intake manifold 21 in this case is an example of “blow-by gas introduced portion”.

What is claimed is:

1. A blow-by gas processing device for an engine including an intake pipe, the blow-by gas processing device comprising a blow-by gas pipe through which blow-by gas flows, wherein:
the blow-by gas flows into the blow-by gas pipe from a base end of the blow-by gas pipe;
the blow-by gas pipe is disposed on a blow-by gas introduced portion that is a part of the intake pipe of the engine;
a peripheral wall of the blow-by gas pipe is provided with a plurality of communication holes arranged in an extending direction of the blow-by gas pipe;
the blow-by gas in the blow-by gas pipe is introduced into the blow-by gas introduced portion through the plurality of communication holes;
a farthest communication hole is provided in a distal end portion of the blow-by gas pipe, the farthest communication hole being included in the plurality of communication holes, and the farthest communication hole being located farthest from the base end of the blow-by gas pipe in the extending direction of the blow-by gas pipe among the plurality of communication holes; and
a guide wall portion is provided in a part of the peripheral wall of the blow-by gas pipe, the part of the peripheral wall being located on an opposite side of a central axis of the blow-by gas pipe from a position of the farthest communication hole, and the guide wall portion being configured to approach the blow-by gas introduced portion as the guide wall portion extends toward a distal end of the blow-by gas pipe in the extending direction of the blow-by gas pipe.

2. The blow-by gas processing device according to claim 1, wherein the guide wall portion is located closer to the distal end of the blow-by gas pipe than a second-farthest communication hole is, the second-farthest communication hole being included in the plurality of communication holes, and the second-farthest communication hole being adjacent to the farthest communication hole in the extending direction of the blow-by gas pipe.

3. The blow-by gas processing device according to claim 1, wherein the blow-by gas processing device is mounted in a vehicle such that the distal end portion of the blow-by gas pipe is a front end portion of the blow-by gas pipe in a front-rear direction of the vehicle.

4. An engine comprising:
an intake pipe including a blow-by gas introduced portion; and
a blow-by gas processing device including a blow-by gas pipe through which blow-by gas flows, wherein
the blow-by gas flows into the blow-by gas pipe from a base end of the blow-by gas pipe,
the blow-by gas pipe is disposed on the blow-by gas introduced portion,
a peripheral wall of the blow-by gas pipe is provided with a plurality of communication holes arranged in an extending direction of the blow-by gas pipe,
the blow-by gas in the blow-by gas pipe is introduced into the blow-by gas introduced portion through the plurality of communication holes,
a farthest communication hole is provided in a distal end portion of the blow-by gas pipe, the farthest communication hole being included in the plurality of communication holes, and the farthest communication hole being located farthest from the base end of the blow-by gas pipe in the extending direction of the blow-by gas pipe among the plurality of communication holes, and
a guide wall portion is provided in a part of the peripheral wall of the blow-by gas pipe, the part of the peripheral wall being located on an opposite side of a central axis of the blow-by gas pipe from a position of the farthest communication hole, and the guide wall portion being configured to approach the blow-by gas introduced portion as the guide wall portion extends toward a distal end of the blow-by gas pipe in the extending direction of the blow-by gas pipe.
